(19) United States
(12) Patent Application Publication
(10) Pub. No.: US 2024/0234950 A9
(43) Pub. Date: Jul. 11, 2024

(54) IMPROVED ADHESIVE COATING, COATED MEMBRANES, COATED BATTERY SEPARATORS, AND RELATED METHODS

(71) Applicant: Celgard, LLC, Charlotte, NC (US)

(72) Inventors: Wenbin Yin, Charlotte, NC (US); Zhengming Zhang, Rock Hill, SC (US); Stefan Reinartz, Waxhaw, NC (US); Takeda Hisashi, Charlotte, NC (US); Xiang Yu, Indian Land, SC (US)

(21) Appl. No.: 18/277,546

(22) PCT Filed: Feb. 4, 2022
(86) PCT No.: PCT/US2022/015164

§ 371 Date: Aug. 16, 2023

Related U.S. Application Data
(60) Provisional application No. 63/150,535, filed on Feb. 17, 2021.

(51) Int. Cl. H01M 50/446; H01M 10/0525; H01M 50/403; H01M 50/417; H01M 50/42; H01M 50/426; H01M 50/434; H01M 50/489

(52) U.S. Cl. CPC H01M 50/446; H01M 10/0525; H01M 50/403; H01M 50/417; H01M 50/42; H01M 50/426; H01M 50/434; H01M 50/489; H01G 9/02

(57) ABSTRACT

A heat-resistant sticky coating for use on a membrane or lithium ion battery separator is disclosed. The coating has at least improved dry adhesion to an electrode for a lithium ion battery. The coating includes heat-resistant particles with a water-soluble sticky polymer on their surface. The water-soluble sticky polymer may be a polyethylene oxide (PEO). The coating may also include particles of water-insoluble sticky polymer. The water-insoluble sticky polymer may be a polyvinylidene fluoride (PVDF) homopolymer, copolymer, or terpolymer. The water-insoluble sticky polymer may be in the same layer of the coating as the heat-resistant particles with the water-soluble sticky polymer on their surface, or it may be in a different layer. A method for forming the heat-resistant sticky coating is also disclosed.

### RELATED APPLICATIONS

This application is a 371 application to PCT Application No. PCT/US2022/015164, filed Feb. 4, 2022, which claims priority to U.S. Provisional Application No. 63/150,535, filed Feb. 17, 2021, which are incorporated herein by reference in their entireties.

### FIELD

The present disclosure relates to an improved sticky coating, particularly to an improved heat-resistant and sticky coating. The improved coating may be applied to a surface of a porous film to form a membrane or battery separator that is sticky. The battery separator may be used in a lithium ion battery.

### BACKGROUND

Heat-resistant coatings have been applied to microporous films used as battery separators to improve safety. Such coatings are described, for example, in Celgard's Patent, RE 47,520 (the '520 patent), which is the seminal patent in this area. The '520 patent is incorporated herein by reference in its entirety.

Water-based coatings that were heat-resistant and contained sticky water-insoluble particles were described, for example, in Celgard's patent publication US 2016/0164060 (the '060 publication), which is incorporated by reference herein in its entirety. These coatings were heat-resistant and exhibited excellent adhesion to the electrodes when wet with electrolyte. This is the “wet sticky” property of the coating. However, adhesion of the coating to the electrodes in the dry state, e.g., during a cell manufacturing process and before electrolyte is added, was lower than desired by some manufacturers. This is the “dry sticky” property of the coating.

Thus, there exists a need for a heat-resistant coating with an improved “dry sticky” property.

### SUMMARY

The invention disclosed herein addresses many of the issues with prior heat-resistant sticky coatings as described hereinabove. For example, the heat-resistant sticky coating described herein may exhibit increased dry adhesion compared to prior heat-resistant sticky coating. The dry adhesion may increase by a factor of two or more.

In one aspect, a sticky heat-resistant coating is described, which comprises heat-resistant particles and a sticky water-soluble polymer. At least a portion of the heat-resistant particles are coated with the sticky water-soluble polymer. The sticky water-soluble polymer is one or more selected from the group consisting of polyethylene oxide, polyvinyl alcohol (PVA), polyvinylpyrrolidone (PVP), or combinations thereof.

The coating may be provided on a base film such as a porous base film. The combination of the coating and the base film may provide a sticky heat-resistant-coated battery separator. The coating may have a thickness of 1 micron to 10 microns. The coating may have one or two or more layers. The base film may be a microporous polyolefin base film.

In the coating, a ratio of heat-resistant particles to sticky water-soluble polymer may be from 1:1 to 15:1. A total amount of heat-resistant particles in the coating may be greater than or equal to 20% or equal to or greater than 50%. The heat-resistant particles comprise at least one selected from the group consisting of SiO₂, Al₂O₃, CaCO₃, TiO₂, SiS₂, SiPO₄, AlO(OH), organic heat-resistant particles, or mixtures thereof.

In some embodiments, the coating further comprises sticky particles made of a water-insoluble sticky polymer. The water-insoluble polymer is one or more selected from the group consisting of a PVDF homopolymer, a PVDF copolymer, a PVDF terpolymer, an acrylic polymer, or mixtures thereof. In some embodiments, the sticky particles made of a water-insoluble sticky polymer may be added in the same layer as the heat-resistant particles and the sticky water-soluble polymer, or in a different layer. For example, in some embodiments, the heat-resistant particles and the sticky water-soluble polymer may be provided in a first layer, and the water-soluble sticky polymer may be provided in a second layer that is on top of the first layer.

In some embodiments, the coating further comprises a binder. The binder may be an acrylic binder. In a coating comprising one, two, or more layers, a binder may be present in one layer, some layers, or each layer. The binder in the layers may be the same or different.

In another aspect, a lithium ion battery that includes the heat-resistant sticky coating or the heat-resistant sticky battery separator described above is described.

In another aspect, a method for forming a sticky heat-resistant coating is described. The method may comprise providing a coating slurry that includes the following: (1) 20% to 99% heat-resistant particles; 5% to 90% polymer, which comprises a water-soluble sticky polymer; and a solvent that consists of or consists essentially of water. At least some of the heat-resistant particles in the slurry are coated with the water-soluble sticky polymer. In some embodiments, the method may involve a step of applying the slurry to a porous base film to form, for example, a sticky heat-resistant battery separator.

In some embodiments, the slurry comprises 50% to 99% heat-resistant particles and 5% to 50% polymer. In others, the slurry comprises 70% to 99% heat-resistant particles and 5 to 25% polymer. In some embodiments, the slurry may further comprise 1 to 10% of a binder.

The water-soluble sticky polymer may be one or more selected from the group consisting of a polyethylene oxide, a polyvinyl alcohol (PVA) or a polyvinylpyrrilodone (PVP), or combinations thereof.

The heat-resistant particles may comprise at least one selected from the group consisting of SiO₂, Al₂O₃, CaCO₃, TiO₂, SiS₂, SiPO₄, AlO(OH), organic heat-resistant particles or mixtures thereof

In some embodiments, the polymer may further comprise a water-insoluble sticky polymer. The water-insoluble polymer is one or more selected from the group consisting of a PVDF homopolymer, a PVDF copolymer, a PVDF terpolymer, an acrylic polymer or mixtures thereof.

In some embodiments, the method may further comprise a step of applying a coating slurry that comprises a water-insoluble sticky polymer. The slurries may be applied in any order. In some embodiments, the slurry comprising the water-insoluble sticky polymer may be applied second.

In some embodiments, the slurry may further comprise one or more additives, which may include dispersant.

### DESCRIPTION OF THE DRAWINGS

FIG. 1 is a schematic drawing showing coating of a heat-resistant particle.

FIG. 2 is a schematic drawing of an exemplary coated separator according to some embodiments described herein.

FIG. 3 is a schematic drawing of an exemplary coated separator according to some embodiments described herein.

FIG. 4 is a table including data collected from some embodiments described herein.

FIG. 5 is a table including data collected from some embodiments described herein.

FIG. 6 is a table including data collected from some embodiments described herein.

FIG. 7 is a table including data collected from some embodiments described herein.

### DETAILED DESCRIPTION

The heat-resistant sticky coating described herein exhibits, among other things, greatly improved dry adhesion compared to prior heat-resistant sticky coatings. The coating may be applied onto one or more surfaces of a porous film. A method for forming the heat-resistant sticky coating is also described.

Such a heat-resistant sticky coating may be useful on a battery separator for a lithium ion battery, including lithium-iron-phosphate (LFP) batteries, lithium nickel manganese cobalt oxide (NMC) batteries, large format lithium batteries, or the like. The heat-resistant coatings may also be useful in capacitors.

Heat-Resistant Sticky Coating

The coating may comprise, consist of, or consist essentially of (1) heat-resistant particles and (2) a water-soluble sticky polymer. In some embodiments, the coating may further comprise (3) a water-insoluble sticky polymer, (4) a binder, or both. Additional components (5), including a dispersant, a surfactant, or other additives may also be added. In the coating, the water-insoluble sticky polymer may be provided in the same layer as the heat-resistant particles and the water-soluble sticky polymer, or it may be provided in a different layer.

In preferred embodiments, the coating may be an aqueous coating, meaning that the coating was formed from a coating slurry where the solvent consists of or consists essentially of water. This means the solvent may include 100% water or water and up to 10% of a polar solvent such as an alcohol, e.g., methanol, ethanol, propanol, or the like. However, the use of an organic solvent is not precluded. In such an embodiment, a polymer that is soluble in the organic solvent and another polymer that is not soluble in the organic solvent may be used.

In other preferred embodiments, the coating may be applied on one or more sides of a porous film. The thickness of the coating may be from 500 nm to 10 microns, from 500 nm to 9 microns, from 500 nm to 8 microns, from 500 nm to 7 microns, from 500 nm to 6 microns, from 500 nm to 5 microns, from 500 nm to 4 microns, from 500 nm to 3 microns, from 500 nm to 2 microns, or from 500 nm to 1 micron.

The coating may be a single layer coating or a coating having two, three, four, five, six, seven, eight, nine, or ten layers. In one preferred embodiment, the coating may be a single layer coating. In another preferred embodiment, the coating may be a two layer coating wherein the total thickness of the coating is as described hereinabove.

The porous is not so limited and may include any nanoporous, microporous, or macroporous film. In some particularly preferred embodiments, the porous film is microporous. For example, the separator may have an average pore size between 0.1 and 1.0 microns.

In some embodiments, the porous film is made from a thermoplastic polymer. The thermoplastic polymer may be a polyolefin.

In some preferred embodiments, the porous film may be a film formed by a dry-stretch process such as the Celgard® dry-stretch process, which does not utilize solvents or oils. The porous film may also be made, in some embodiments, using a wet process that utilizes solvents or oils to form pores.

(1) Heat Resistant Particles

An amount of heat-resistant particles in the coating may be from 10 wt. % to 99 wt. %, from 20 wt. % to 95 wt. %, from 30 wt. % to 90 wt. %, from 40 wt. % to 85 wt. %, from 45 wt. % to 80 wt. %, from 50 wt. % to 75 wt. %, from 55 wt. % to 70 wt. %, or from 60 to 65 wt. %. Use of less than 10 wt. %, less than 15 wt. %, or less than 20 wt. % may not result in a coating with sufficient heat-resistance to improve safety in a lithium ion battery.

The heat-resistant particles are not so limited and may be organic or inorganic heat-resistant particles. Examples of inorganic heat-resistant particles include iron oxides, silicon dioxide (SiO₂), aluminum oxide (Al₂O₃), boehmite (Al(O)OH), zirconium dioxide (ZrO₂), titanium dioxide (TiO₂), barium sulfate (BaSO₄), barium titanium oxide (BaTiO₃), aluminum nitride, silicon nitride, calcium fluoride, barium fluoride, zeolite, apatite, kaoline, mullite, spinel, olivine, mica, tin dioxide (SnO₂), indium tin oxide, oxides of transition metals, metal, and any combinations thereof. Examples of organic heat-resistant materials may include polyimides, polybenzimidazoles (PBIs), Polyamide, etc.

The size of the heat-resistant particles is not so limited and may be from 50 nanometers to 5 microns, from 100 nm to 4 microns, from 200 nm to 3 microns, from 300 nm to 2 microns, from 400 nm to 1 micron, or from 500 nm to 2 microns.

The shape of the heat-resistant particles is also not so limited and may be spherical, irregular, plate-shaped, or the like.

In preferred embodiments, at least some of the heat-resistant particles are coated with a water-soluble sticky polymer. This means that 10% or more, 20% or more, 30% or more, 40% or more, 50% or more, 60% or more, 70% or more, 80% or more, 90% or more, 95% or more, or 100% of the heat-resistant particles are coated with a water-soluble sticky polymer. In preferred embodiments, the water-soluble sticky polymer is coated directly on a surface of the heat-resistant particles.

These coated heat-resistant particles comprise a water-soluble sticky polymer coating 50% or more, 60% or more, 70% or more, 80% or more, 90% or more, or 100% of a surface of the particles. The result may be a core-shell structure where the core is a heat-resistant particle and the shell is a water-soluble sticky polymer coating, Without wishing to be bound by any particular theory, it is believed that this structure is at least partially responsible for the increase in dry adhesion observed. In prior coatings, surfaces of the heat-resistant particles were bare and exposed at a surface of the coating. These bare surfaces did not adhere well to the electrode material.

To achieve the foregoing, a ratio of heat-resistant particle to water-soluble sticky polymer should be in a range from 1:1 to 25:1, from 1:1 to 20:1, from 1:1 to 15:1, from 1:1 to 10:1, or from 1:1 to 5:1. Use of a ratio above 25:1 may not result in sufficient coating of the water-soluble sticky polymer on the surfaces of the heat-resistant particles.

(2) Water-Soluble Sticky Polymer

For purposes herein, a water-soluble polymer includes any polymer that would be characterized as “very soluble,” “freely soluble” or “soluble” according to Table 1 below.

TABLE 1

| | Parts of water solvent | Solubility Range in |
|---|---|---|
| Solubility in water | required for 1 part of solute | water (mg/ml) |
| very soluble | <1 | ≥1000 |
| freely soluble | From1 to 10 | 100-1000 |
| soluble | From 10 to 30 | 33-100 |
| sparingly soluble | From 30 to 100 | 10-33 |
| slightly soluble | From 100 to 1000 | 1-10 |
| very slightly soluble | From 1000 to 10000 | 0.1-1 |
| practically insoluble | ≥10000 | <0.1 |

A water-soluble sticky polymer includes any polymer that reaches or comes close to (±5° C.) its melting point in a range from 60° C. to 120° C. For example, polyethylene oxide has a Tm of 65° C. Such a polymer would be considered “dry sticky” because it reaches or comes close to its melting point (it starts to melt and adhere to the electrodes) at typical temperatures reached during a cell manufacturing process, e.g., temperatures from about 50 to about 110° C. Adhesion to the electrode from about 5 N/m to about 10 N/m is acceptable adhesion strength. Adhesion from about 10 N/m to about 30 N/m or greater is excellent adhesion strength.

Examples of water-soluble sticky polymers that may be used include but are not limited to a polyethylene oxide (PEO), a polyvinyl alcohol (PVA), a polyvinylpyrrilodone (PVP), or combinations of the foregoing. PEO may be preferred for use in a coating for a lithium ion battery separator as it is also ionically conductive.

In some embodiments, the water-soluble sticky polymer may be a co-polymer of one water-soluble polymer and another water-soluble polymer that exhibits improved adhesion or compatibility with at least one of the heat-resistant particles used. For example, a copolymer of a polyethylene oxide (PEO), a polyvinyl alcohol (PVA), or a polyvinylpyrrilodone (PVP), and at least one other polymer may be used. For example, the other polymer may be more hydrophilic than PEO if alumina particles are used or more hydrophobic if polymeric heat-resistant particles are used.

The water-soluble sticky polymer may also exhibit “wet sticky” properties as described herein.

(3) Water-Insoluble Sticky Polymer

For purposes herein, a “water-insoluble” polymer includes any polymer that would be characterized as “sparingly soluble, “very slightly soluble,” or “practically insoluble” according to Table 1.

For purposes herein, a water-insoluble sticky polymer includes polymers that adhere to an electrode material when wetted with an electrolyte used in a lithium ion battery. Such a polymer would be considered a “wet sticky” polymer. Adhesion to the electrode from about 5 N/m to about 10 N/m is acceptable adhesion strength, Adhesion from about 10 N/m to about 30 N/m or greater is excellent adhesion strength.

The water-insoluble sticky polymer may also exhibit “dry sticky” properties as described herein.

Examples of water-insoluble sticky polymers that may be used include, but are not limited to, a PVDF homopolymer, a PVDF copolymer, a PVDF terpolymer, an acrylic polymer, or combinations of the foregoing.

Particles of the water-insoluble sticky polymer in the coating are not limited in size. For example, the particles may have a size from 50 nanometers to 5 microns, from 100 nm to 4 microns, from 200 nm to 3 microns, from 300 nm to 2 microns, from 400 nm to 1 micron, or from 500 nm to 2 microns.

In some preferred embodiments, the water-insoluble sticky polymer may be provided in a layer of the coating that is separate from the layer comprising the heat-resistant particles and the water-soluble sticky polymer. In other preferred embodiments, the water-insoluble polymer may be provided in the same layer as the heat-resistant particles and the water-soluble sticky polymer.

(4) Binder

Use of a binder may not be required but is also not excluded.

Typically, a binder is added to a heat-resistant coating to, among other things, maintain the integrity of the coating. Typically, a binder is not added in an amount more than 10%, 9%, 8%, 7%, 6%, 5%, 4%, 3%, 2%, or 1%.

The binder is not so limited. Any binder suitable for use in a lithium ion battery may be used. In some embodiments, the binder may be an acrylic polymer. The binder may also be a polylactam binder polyvinyl alcohol (PVA), polyacrylic acid (PAA), polyvinyl acetate (PVAc), carboxymethyl cellulose (CMC), polyvinylpyrolidone (PVP) or mixtures thereof.

In a coating comprising two or more layers, each layer may comprise a binder, and the binder in the layers may be the same or different.

(5) Additives

One or more additives may be included in the coating. The one or more additives may be include a surfactant, a dispersant, a colorant, an anti-static, or combinations of the foregoing.

In a coating comprising two or more layers, each layer may comprise additives, and the additives in the layers may be the same or different.

Method

A method for forming a sticky heat-resistant coating may comprise, consist of, or consist essentially of a step of forming a coating slurry. The method may further comprise, consist of, or consist essentially of applying the slurry to one or more surfaces of a porous film. The method may further comprise, consist of, or consist essentially of a step of drying the slurry applied to one or more surfaces of a porous film to form the sticky heat-resistant coating.

(1) Forming the Coating Slurry

Forming the coating slurry may comprise, consist of, or consist essentially of a step of combining heat-resistant particles with a water-soluble sticky polymer so that a surface of at least some of the heat-resistant particles is coated with the water-soluble sticky polymer. In some preferred embodiments, an entire surface of at least some of the heat-resistant particles is coated with the water-soluble sticky polymer forming a core-shell structure where the heat-resistant particles are the core and the water-soluble sticky polymer coating is the shell. This may be achieved by combining the heat-resistant particles and the water-soluble sticky polymer in water as the solvent to form a mixture. A dispersant may also be added to the mixture. Then mixing, agitation or the like may be performed so that the water-soluble sticky polymer coats a surface of at least some of the heat-resistant particles. For example, mixing, agitation, or the like may be performed for 5 or more minutes, 10 or more minutes, 15 or more minutes, 20 or more minutes, 25 or more minutes, or 30 or more minutes. The resulting mixture includes heat-resistant particles coated with the water-soluble sticky polymer.

In a next step, this mixture with heat-resistant particles coated with the water-soluble sticky polymer in water may be combined with a water-insoluble sticky polymer. For example, in some embodiments, a dispersion (emulsion) of PVDF particles in water may be combined with the mixture with heat-resistant particles coated with the water-soluble sticky polymer in water.

However, in some embodiments, this mixture may not be combined with the water-insoluble sticky polymer. In such embodiments, a slurry comprising the water-insoluble sticky polymer may be separately formed and the slurries may be separately coated.

A binder and other additives may also be added to either of the above-described coating slurries.

(2) Applying a Coating Slurry

The method may comprise, consist of, or consist essentially of applying a coating slurry to at least one side of a porous base film. The thickness of the applied coating slurry may be from 500 nm to 10 microns, from 500 nm to 9 microns, from 500 nm to 8 microns, from 500 nm to 7 microns, from 500 nm to 6 microns, from 500 nm to 5 microns, from 500 nm to 4 microns, from 500 nm to 3 microns, from 500 nm to 2 microns, or from 500 nm to 1 micron. The slurry may comprise, consist of, or consist essentially of: (a) 20% to 99% heat-resistant particles; (b) 5% to 90% polymer, which comprises a water-soluble sticky polymer; and (c) a solvent that consists of or consists essentially of water. In some embodiments, the slurry may further comprise a binder (d) or other additives (e).

In some embodiments, a coating slurry comprising the heat-resistant particles and the sticky water-soluble polymer is coated separately from a slurry comprising the water-insoluble sticky polymers to form two separate layers of the coating. In some embodiments, a coating slurry comprising the heat-resistant particles and the sticky water-soluble polymer is coated first, and a slurry comprising the water-insoluble sticky polymers is coated on top.

At least some of the heat-resistant particles are coated with the water-soluble sticky polymer. This means that 10% or more, 20% or more, 30% or more, 40% or more, 50% or more, 60% or more, 70% or more, 80% or more, 90% or more, 95% or more, or 100% of the heat-resistant particles are coated with a water-soluble sticky polymer. In preferred embodiments, the water-soluble sticky polymer is coated directly on a surfaces of the heat-resistant particles. These coated heat-resistant particles comprise a water-soluble sticky polymer coating 50% or more, 60% or more, 70% or more, 80% or more, 90% or more, or 100% of a surface of the particles. The result may be a core-shell structure where the core is a heat-resistant particle and the shell is a water-soluble sticky polymer coating

(a) Heat-Resistant Particles

The Heat-resistant particles are as described herein above.

Amounts of the heat-resistant particles in the slurry may be from 20% to 99%, from 25% to 99%, from 30% to 99%, from 35% to 99%, from 40% to 99%, from 45% to 99%, from 50% to 99%, from 55% to 99%, 60% to 99%, from 65% to 99%, from 70% to 99%, from 75% to 99%, from 80% to 99%, from 85% to 99%, from 90% to 99%, or from 95% to 99%.

(b) Polymer

The amount of polymer in the slurry may be from 5% to 90%, from 10% to 90%, from 15% to 90%, from 20% to 90%, from 25% to 90%, from 30% to 90%, from 35% to 90%, from 40% to 90%, from 45% to 90%, from 50% to 90%, from 55% to 90%, from 60% to 90%, from 65% to 90%, from 70% to 90%, from 75% to 90%, from 80% to 90%, or from 85% to 90%.

The polymer may comprise, consist of, or consist essentially of a water-soluble sticky polymer as described hereinabove or a water-soluble sticky polymer and a water-insoluble sticky polymer as described hereinabove.

A ratio of heat-resistant particle to water-soluble sticky polymer should be in a range from 1:1 to 25:1, from 1:1 to 20:1, from 1:1 to 15:1, from 1:1 to 10:1, or from 1:1 to 5:1.

Where the polymer comprises, consists of, or consists essentially of a water-soluble sticky polymer and a water-insoluble sticky polymer, a ratio of the water-soluble sticky polymer to the water-insoluble sticky polymer may be from 1:100 to 100:1, from 1:75 to 75:1, from 1:50 to 50:1, from 1:25 to 25:1, from 1:20 to 20:1, from 1:15 to 15:1, from 1:10 to 10:1, from 1:5 to 5:1, or from 1:2 to 2:1.

(c) Solvent

Preferably, the solvent consists of or consists essentially of water. This means the solvent may include 100% water or water and up to 10% of a polar solvent such as an alcohol, e.g., methanol, ethanol, or propanol. Addition of such solvent may make drying the applied slurry easier.

Though use of aqueous solvents is preferred, the use of an organic solvent is not precluded. In such an embodiment, a polymer that is soluble in the organic solvent and another polymer that is not soluble in the organic solvent may be used instead of a polymer that is water-soluble, and a polymer that is water-insoluble, respectively.

(d) Binder

The binder is as described herein above.

Amounts of binder in the slurry are not so limited, but may be from 1% to 10%, from 1% to 9%, from 1% to 8%, from 1% to 7%, from 1% to 6%, from 1% to 5%, from 1% to 4%, from 1% to 3%, or from 1% to 2%.

(e) Additives

One or more additives may be included in the coating. The one or more additives may be include a surfactant, a dispersant, a colorant, an anti-static, or combinations of the foregoing.

Additives may be added in an amount from 0.01% to 10%, from 0.1% to 9%, from 0.5% to 8%, from 1% to 7%, from 1% to 6%, from 1% to 5%, from 1% to 4%, from 1% to 3%, or from 1% to 2%.

(3) Drying the Coating Slurry

This step may comprise, consist of, or consist essentially of applying heat, air, or both to dry the coated slurry, removing water, solvent, or both. In embodiments where the coating includes applying two or more different slurries to provide two or more different layers, a drying step may be required between the coating steps.

### EXAMPLES

### Inventive Coating Example 1

An aqueous coating slurry containing 70% alumina, 23% polymer, which includes a PVDF water-based latex and polyethylene oxide (PEO), and 1-3% acrylic binder was formed. The ratio of alumina to PEO is 7:1. PEO has an average Mv of 100,000. Mixing/agitation was performed to coat the alumina with PEO. A three-micron coating was then formed on a porous polyolefin film. The coating was dried to remove water.

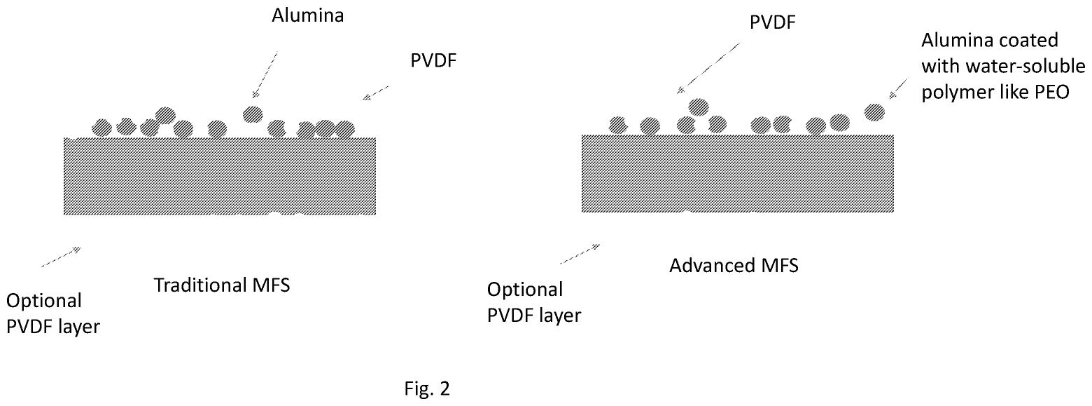

Embodiments like Inventive Coating Example 1 are shown in FIG. 2 on the right-hand side.

### Comparative Coating Example 1

An aqueous coating slurry comprising 70% alumina, 23% PVDF water-based latex, and 1-3% acrylic binder was formed. A three-and-a-half micron coating was then formed on a porous polyolefin film. The coating was dried to remove water.

Embodiments like Comparative Coating Example 1 are shown in FIG. 2 on the left-side.

Dry Electrode Adhesion was measured by hot press method. The 3*3 cm electrodes were cut and placed on top of separator strip with 4*15 cm. The pressure were set at 1 Mpa and the temp is set up at 80, 95 or 115 C. The samples were placed at hot press equipment at a certain Temp with pressure for 10 s. Then the adhered samples were tested by peeling off strength equipment to check the adhesion.

MD shrinkage was measured by cutting samples with 8*8 cm square, make mark on both of MD and TD directions. Then samples were placed into 150° C. oven for 1 h treatment. The sample were measured dimension again after heat treatment. The shrinkage is tested by: (original length−final length)/original length.

TD shrinkage was measured by cutting samples with 8*8 cm square, make mark on both of MD and TD directions. Then samples were placed into 150° C. oven for 1 h treatment. The sample were measured dimension again after heat treatment. The shrinkage is tested by: (original length−final length)/original length.

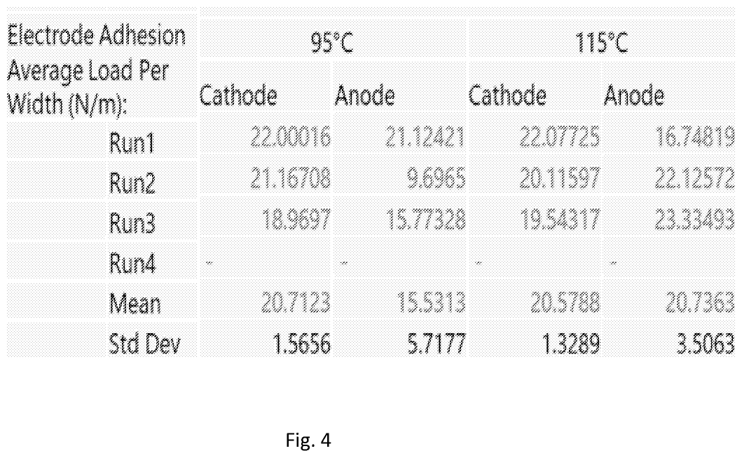

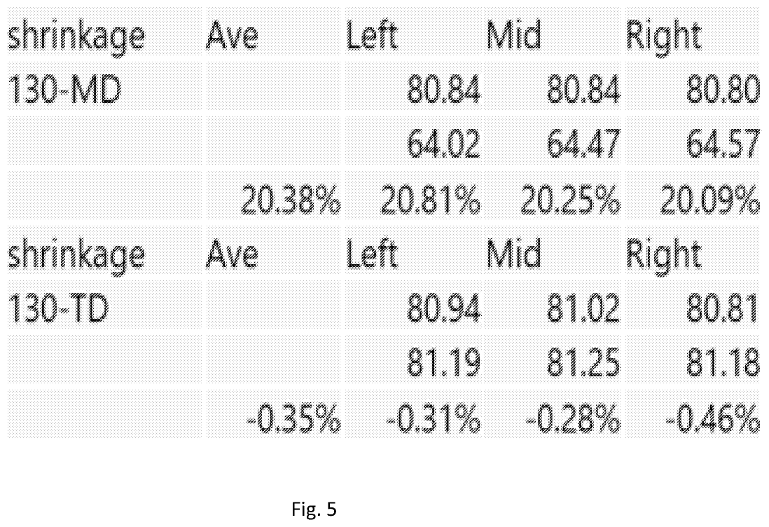

Inventive Example 1 Results are shown in FIG. 4 and FIG. 5.

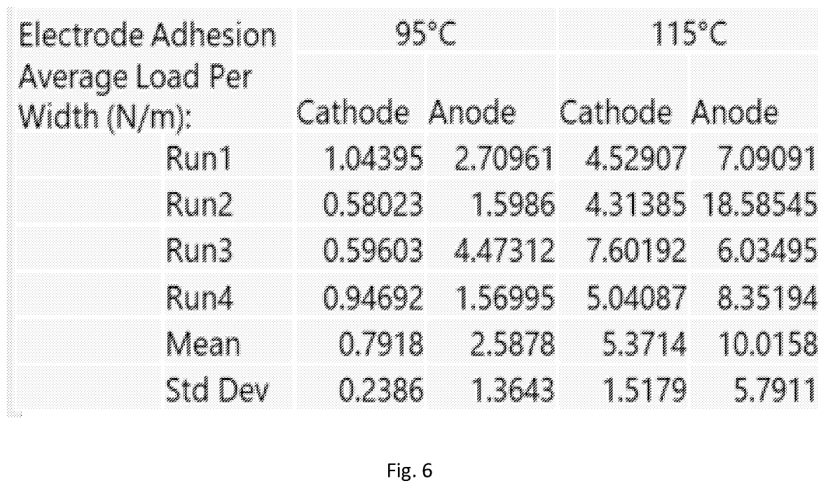

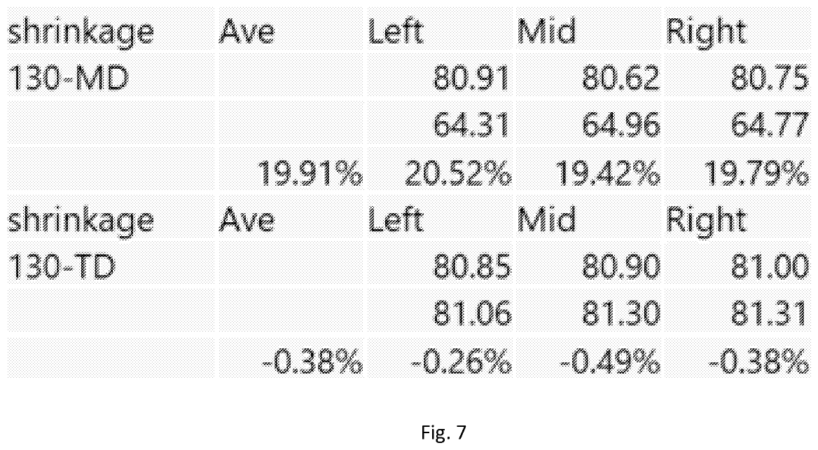

Comparative Example 1 Results are shown in FIG. 6 and FIG. 7.

As can be seen by comparing the inventive results, where a water-soluble sticky polymer is added, with the comparative results, where it is not, it can be seen that dry adhesion at least doubles (compare adhesion to anode at 115° C. results) and in some cases increases by a factor of more than twenty (compare adhesion to cathode at 95° C. results).

The inventive embodiments also exhibited a dry adhesion of greater than 10 N/m when tested as described above at a temperature of 80° C. This means the inventive samples show excellent dry adhesion even at lower temperatures. Inventive embodiments exhibit dry adhesion strengths greater than 10 N/m at temperatures as low as 70° C., 60° C., 50° C. or lower.

### Inventive Coating Example 2

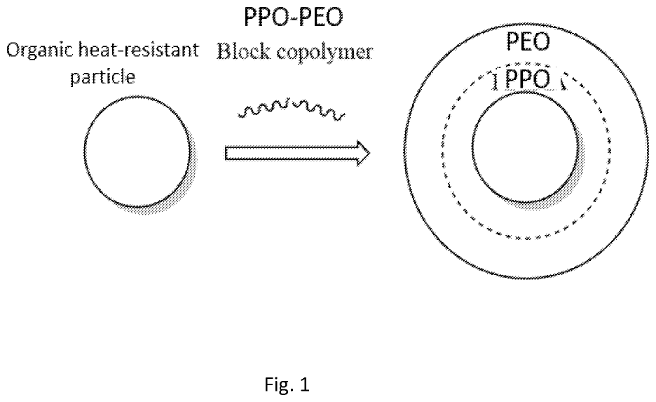

This Example is like the Inventive Example above, except that a co-polymer is used, and organic heat-resistant particles, which will be more hydrophobic than alumina, are used. A copolymer such as PPO-PEO copolymer may be used here, and the polypropylene oxide (PPO) is more compatible with the organic heat-resistant particle because it is a more hydrophobic polymer than PEO. This example is depicted in FIG. 1.

### Inventive Coating Example 3

An aqueous coating slurry comprising PEO and alumina was formed. Agitation/mixing was performed to coat the alumina with PEO. Another aqueous coating slurry comprising PVDF was formed. First, the coating slurry with PEO and alumina was provided on at least one side of a porous base film. Then the coating comprising PVDF was coated on top.

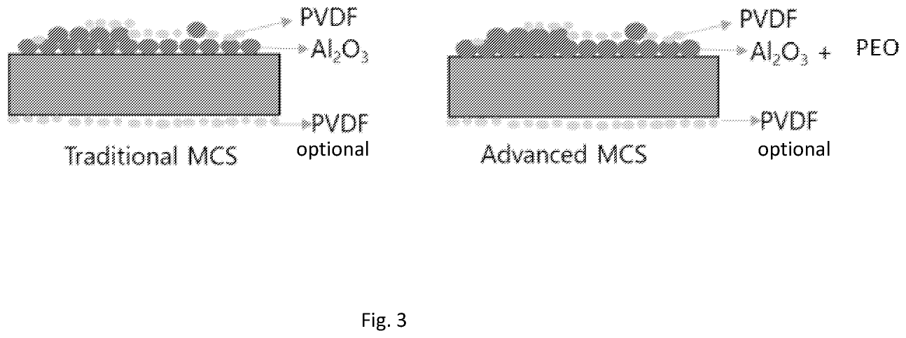

Embodiments like Inventive Coating Example 3 are shown in FIG. 3 on the right-hand side.

Coating the ceramic (alumina) separately can improve thermal stability. In addition, coating the water-insoluble polymer (PVDF) separately provides increased wet adhesion, ion conductivity, etc. Like in Inventive Coating Example 1, providing the water-soluble polymer (PEO) on a surface of the alumina results in improved dry adhesion. Exposed alumina have adhesion due to the presence of PEO on their surface.

### Comparative Example 2

Comparative Example 2 is like Inventive Coating Example 3 except that PEO (or another water-soluble sticky polymer) is not added to the aqueous coating slurry comprising alumina. The resulting coating has lower dry adhesion than that in Inventive Coating Example 3.

Embodiments like Comparative Example 2 are shown in FIG. 3 on the left-hand side.

1-53. (canceled)

54. A sticky heat-resistant coated separator comprising:
a porous base film; and
a sticky heat-resistant coating on at least one side of the base film, wherein the sticky heat-resistant coating layer comprises heat-resistant particles and a sticky water-soluble polymer, wherein at least a portion of the heat-resistant particles are coated with the sticky water-soluble polymer.

55. The separator of claim 54, wherein a ratio of heat-resistant particles to sticky water-soluble polymer is from 1:1 to 15:1, wherein the sticky heat-resistant coating further comprises sticky particles made of a water-insoluble sticky polymer, and the water-insoluble sticky polymer may be in the same layer of the coating as the heat-resistant particles and the sticky water-soluble polymer or in a different layer of the coating, wherein a total amount of heat-resistant particles in the coating is greater than or equal to 20% or equal to or greater than 50%, wherein heat-resistant particles comprise at least one selected from the group consisting of SiO₂, Al₂O₃, CaCO₃, TiO₂, SiS₂, SiPO₄, AlO(OH), or mixtures thereof, wherein the coating layer further comprises a binder, wherein the binder comprises an acrylic binder, wherein the coating has a thickness of 1 to 10 microns, or wherein the porous base film is a microporous polyolefin base film.

56. The separator of claim 54, wherein the sticky heat-resistant coating further comprises sticky particles made of a water-insoluble sticky polymer, and the water-insoluble sticky polymer may be in the same layer of the coating as the heat-resistant particles and the sticky water-soluble polymer or in a different layer of the coating, and wherein the water-insoluble polymer is one or more selected from the group consisting of a PVDF homopolymer, a PVDF copolymer, a PVDF terpolymer, an acrylic polymer, or mixtures thereof.

57. The separator of claim 54, wherein the sticky water-soluble polymer is one or more selected from the group consisting of polyethylene oxide, polyethylene oxide based co-polymer, polyvinyl alcohol (PVA), polyvinylpyrrolidone (PVP), or combinations thereof.

58. A lithium ion battery comprising the separator of claim 54.

59. A method for forming a sticky heat-resistant coated separator, comprising:
applying a coating slurry to at least one side of a porous base film, wherein the slurry comprises:
20% to 99% heat-resistant particles;
5% to 90% polymer, which comprises a water-soluble sticky polymer; and
a solvent that consists of or consists essentially of water, wherein at least some of the heat-resistant particles are coated with the water-soluble sticky polymer.

60. The method of claim 59, wherein the coating slurry further comprises 1 to 10% of a binder, wherein the polymer further comprises a water-insoluble sticky polymer, wherein the slurry comprises 50% to 99% heat-resistant particles and 5% to 50% polymer, wherein the slurry comprises 70% to 99% heat-resistant particles and 5 to 25% polymer, wherein the slurry further comprises one or more additives, which may include dispersant, wherein heat-resistant particles comprise at least one selected from the group consisting of SiO₂, Al₂O₃, CaCO₃, TiO₂, SiS₂, SiPO₄, AlO(OH), or mixtures thereof, wherein the solvent consists of water, wherein the solvent consists essentially of water, wherein the water-soluble polymer is one or more selected from the group consisting of a polyethylene oxide, a polyethylene oxide co-polymer a polyvinyl alcohol (PVA) or a polyvinylpyrrilodone (PVP), or combinations thereof, or wherein the water-insoluble polymer is one or more selected from the group consisting of a PVDF homopolymer, a PVDF copolymer, a PVDF terpolymer, an acrylic polymer or mixtures thereof.

61. The separator of claim 54, wherein the sticky water-soluble polymer is a co-polymer, wherein one polymer of the co-polymer is more compatible with at least one of the heat resistant particle than another polymer of the co-polymer is.

62. The separator of claim 61 wherein the co-polymer is a PPO-PEO copolymer and the heat resistant particles comprise organic heat resistant particles.

63. The method of claim 59, wherein the sticky water-soluble polymer is a co-polymer, wherein one polymer of the co-polymer is more compatible with at least one of the heat resistant particles than another polymer of the co-polymer is.

64. The separator of claim 63, wherein the co-polymer is a PPO-PEO copolymer and the heat resistant particles comprise organic heat resistant particles.

65. A sticky heat-resistant coated polymer membrane comprising:
a porous base film; and
a sticky heat-resistant coating on at least one side of a porous or microporous polymer membrane base film, wherein the sticky heat-resistant coating comprises heat-resistant particles and a sticky water-soluble polymer, wherein at least a portion of the heat-resistant particles are coated with the sticky water-soluble polymer.

66. The membrane of claim 65, wherein a ratio of heat-resistant particles to sticky water-soluble polymer is from 1:1 to 15:1.

67. The membrane of claim 65, wherein the sticky heat-resistant coating further comprises sticky particles made of a water-insoluble sticky polymer, and the water-insoluble sticky polymer may be in the same layer of the coating as the heat-resistant particles and the sticky water-soluble polymer or in a different layer of the coating.

68. The membrane of claim 65, wherein a total amount of heat-resistant particles in the coating is greater than or equal to 20% or equal to or greater than 50%.

69. The membrane of claim 65, wherein heat-resistant particles comprise at least one selected from the group consisting of SiO₂, Al₂O₃, CaCO₃, TiO₂, SiS₂, SiPO₄, AlO(OH), or mixtures thereof, wherein the coating layer further comprises a binder, wherein the binder comprises an acrylic binder, wherein the coating has a thickness of 1 to 10 microns, or wherein the base film is a microporous polyolefin base film.

70. The membrane of claim 67, wherein the water-insoluble polymer is one or more selected from the group consisting of a PVDF homopolymer, a PVDF copolymer, a PVDF terpolymer, an acrylic polymer, or mixtures thereof.

71. The membrane of claim 65, wherein the sticky water-soluble polymer is one or more selected from the group consisting of polyethylene oxide, polyethylene oxide based co-polymer, polyvinyl alcohol (PVA), polyvinylpyrrolidone (PVP), or combinations thereof.

72. A textile, filter, laminate, separator, capacitor, or battery comprising the membrane of claim 65.

73. A method for forming the sticky heat-resistant coated membrane of claim 65, comprising:
applying a coating slurry to at least one side of a porous or microporous polymer membrane base film, wherein the slurry comprises:
20% to 99% heat-resistant particles;
5% to 90% polymer, which comprises a water-soluble sticky polymer; and
a solvent that consists of or consists essentially of water, wherein at least some of the heat-resistant particles are coated with the water-soluble sticky polymer.

74. The method of claim 73, wherein the coating slurry further comprises 1 to 10% of a binder, wherein the polymer further comprises a water-insoluble sticky polymer, wherein the slurry comprises 50% to 99% heat-resistant particles and 5% to 50% polymer, wherein the slurry comprises 70% to 99% heat-resistant particles and 5 to 25% polymer, or wherein the base film is a microporous single layer or multilayer polyolefin base film, preferably a dry process microporous single layer or multilayer polyolefin base film made mainly of polyethylene and/or polypropylene.

75. The separator of claim 54, wherein the sticky heat-resistant coating further comprises sticky particles made of a water-insoluble sticky polymer, and the water-insoluble sticky polymer may be in the same layer of the coating as the heat-resistant particles and the sticky water-soluble polymer or in a different layer of the coating, and wherein the water-insoluble sticky polymer is in the same layer of the coating as the heat-resistant particles and the sticky water-soluble polymer, or wherein the water-insoluble sticky polymer is in a different layer of the coating than the heat-resistant particles and the sticky water-soluble polymer are in.

76. The method of claim 59, further comprising applying another coating slurry, wherein the another coating slurry comprises the water-insoluble sticky polymer, and the coating slurries are applied in any order.

77. The method of claim 76, wherein the another coating slurry is applied second.

78. The membrane of claim 67, wherein the water-insoluble sticky polymer is in the same layer of the coating as the heat-resistant particles and the sticky water-soluble polymer.

79. The membrane of claim 67, wherein the water-insoluble sticky polymer is in a different layer of the coating than the heat-resistant particles and the sticky water-soluble polymer are in.

80. The method of claim 73, further comprising applying another coating slurry, wherein the another coating slurry comprises the water-insoluble sticky polymer, and wherein the coating slurries are applied in any order.

81. The method of claim 80, wherein the another coating slurry is applied second.
